(19) United States
(12) Patent Application Publication
(10) Pub. No.: US 2003/0231996 A1
(43) Pub. Date: Dec. 18, 2003

(54) Method for adsorbing lithium ions from a lithium-containing aqueous solution by a granular adsorbent

(75) Inventors: Jer-Yuan Shiu, Hsinchu (TW); Jiunn-Ren Lin, Hsinchu (TW); Dzu-Chi Lee, Hsinchu (TW); Yung-Min Chen, Hsinchu (TW); Chih-Chung Liu, Hsinchu (TW)

Correspondence Address: BACON & THOMAS, 4th Floor, 625 Slaters Lane, Alexandria, VA, 22314, US

(73) Assignee: Industrial Technology Research Institute, Hsinchu (TW)

(21) Appl. No.: 10/173,177

(22) Filed: Jun. 18, 2002

(51) Int. Cl. B01D 15/00

(52) U.S. Cl. 423/179.5; 210/660

(57) ABSTRACT

A lithium-containing aqueous solution is contacted with a granular adsorbent of lithium-containing manganese oxide to adsorb lithium ions from the aqueous solution on the adsorbent, wherein an alkali is added to the aqueous solution to raise the pH value thereof to about 10 or above prior to the adsorption, thereby the saturated amount of lithium ions adsorbed per gram of adsorbent is increased from about 6 mg to about 25 mg.

### FIELD OF THE INVENTION

The present invention is related to a method for adsorbing lithium ions from a lithium-containing aqueous solution by an adsorbent, and in particular to a method for adsorbing lithium ions from seawater or brine by a granular adsorbent.

### BACKGROUND OF THE INVENTION

Due to its merits, such as a high electrical energy density, a high working voltage, a long cyclic life and no memory effect, etc., the lithium ion battery has been widely used in notebook computer, mobile phone, and electric cars, and the use amount thereof will grow in multiples. In addition, many different lithium compounds have been utilized in various industries, such as ceramic industry, glass industry, aluminum electrolysis melting industry and synthetic rubber industry. Among them the most popular lithium compound is lithium carbonate, and many lithium compounds are derived from lithium carbonate. Therefore, lithium carbonate is one of the most important lithium compounds.

Currently, two different sources of raw materials are used to produce lithium carbonate, which are lithium ores and brine. In a country like Taiwan where no nature resource of lithium ores can be found, seawater is the only alternative resource for producing lithium carbonate. Seawater can be used directly or after concentrated, i.e brine, wherein seawater has a lithium concentration of about 0.1-0.5 ppm, and brine has a lithium concentration of about 10 ppm. In order to form lithium carbonate precipitate from an aqueous solution containing lithium ions, the concentration thereof must be 15000 ppm or higher, which is much higher than those of seawater and brine. Consequently, there is a great interest in developing a technique for raising the lithium ion concentration of the seawater or brine to a level of 15000 ppm required for producing lithium carbonate.

U.S. Pat. No. 4,665,049 discloses an adsorbent for lithium in an aqueous medium capable of adsorbing the lithium value even when the concentration of lithium in the aqueous medium is very low as in natural seawater so as to give an adsorbed amount of lithium on the adsorbent comparable to the content in some low-grade lithium ores. The inventive adsorbent is prepared by the steps comprising (a) impregnating a manganese compound with an alkali, e.g. sodium and potassium, or akaline earth, e.g. magnesium and calcium, metal compound by the adsorption of the impregnant in an aqueous solution on to a water-insoluble manganese compound, coprecipitation of manganese and the impregnant element by admixing aqueous solutions of compounds thereof or powder blending of a manganese compound and an impregnant compound, (b) heat-treating the thus impregnated manganese compound at a temperature sufficiently high to form a composite compound between manganese and the impregnant element and (c) leaching the constituent of the impregnant out of the composite manganese compound after the heat treatment using an acid. The adsorbent so prepared is in the form of powder, and thus is susceptible to suffer weight loss and an undue large pressure drop when it is packed into a column.

Japanese patent publication No.3-008439 discloses a granular adsorbent of lithium-containing manganese oxide. The lithium-containing manganese oxide, such as LiMn₂O₄ or Li₂MnO₃, is added into the solution prepared by dissolving an organic high polymer material having a binder function into an organic solvent (such as dimethylformamide; DMF) and is then sufficiently kneaded. The mixture is passed through a capillary in a liquid which has affinity to the organic solvent and is a nonsolvent to the high-polymer material, by which the granular matter is produced. The granular matter is then immersed into an aqueous solution containing an acid having the lithium elutability or an oxidative material exhibiting acidity to elute the lithium. The granular lithium adsorbent is thus obtained. This adsorbent is packed into a column where the dilute solution containing the lithium is passed to adsorb the lithium on the adsorbent. A solution for desorbing the lithium is then passed in the column to elute the lithium adsorbed on the adsorbent. The DMF solvent used in this patent application is a toxic solvent under restriction, which is detrimental to the environment, and thus is not suitable for use in a large-scale production of the granular adsorbent.

### SUMMARY OF THE INVENTION

A primary object of the present invention is to provide a method for adsorbing lithium ions from a lithium-containing aqueous solution by an adsorbent of lithium-containing manganese oxide, which has an enhanced saturated amounts of Li⁺ adsorbed per gram of the adsorbent.

Another object of the present invention is to provide a method for adsorbing lithium ions from a lithium-containing aqueous solution by a granular adsorbent of lithium-containing manganese oxide, wherein the granular adsorbent is prepared with an organic solvent which is relatively low toxic to the environment.

According to the present invention, a lithium-containing aqueous solution is contacted with a granular adsorbent of lithium-containing manganese oxide to adsorb lithium ions from the aqueous solution on the adsorbent, wherein an alkali is added to the aqueous solution to raise the pH value thereof not lower than 10, preferably 11, prior to the adsorption, thereby the saturated amount of lithium ions adsorbed per gram of adsorbent is increased to about 25 mg, which is significantly higher than 6 mg/g adsorbent when the lithium-containing aqueous solution is of pH 7.

### BRIEF DESCRIPTION OF THE DRAWINGS

FIG. 1 is a block diagram showing a mass balance scheme for preparing a granular adsorbent according to a preferred embodiment of the present invention.

FIG. 2 shows the results of isothermal adsorption test by using the granular adsorbent prepared in Example 1 in LiCl aqueous solutions of various concentrations at pH=7 and 25° C., wherein the x-axis represents the equilibrium concentration of LiCl in the aqueous solution and the y-axis represents the saturated amount of Li⁺ adsorbed per gram of the adsorbent.

FIG. 3 shows the results of isothermal adsorption test by using the granular adsorbent prepared in Example 2 in LiCl aqueous solutions of various concentrations at pH=7 and 25° C., wherein the x-axis represents the concentration of the initial LiCl aqueous solution and the y-axis represents the saturated amount of Li⁺ adsorbed per gram of the adsorbent.

FIG. 4 shows the results of isothermal adsorption test by using the granular adsorbent prepared in Example 1 in LiCl aqueous solutions of various concentrations at pH=11 and 25° C., wherein the x-axis represents the equilibrium concentration of LiCl in the aqueous solution and the y-axis represents the saturated amount of Li⁺ adsorbed per gram of the adsorbent.

FIG. 5 shows the results of isothermal adsorption test by using the granular adsorbent prepared in Example 2 in LiCl aqueous solutions of various concentrations at pH=11 and 25° C., wherein the x-axis represents the concentration of the initial LiCl aqueous solution and the y-axis represents the saturated amount of Li⁺ adsorbed per gram of the adsorbent.

### DETAILED DESCRIPTION OF THE INVENTION

The present invention is directed to a method for adsorbing lithium ions from a lithium-containing aqueous solution by an using adsorbent of lithium-containing manganese oxide, and in particular to a method for adsorbing lithium ions from seawater, or brine generated from a process for producing salt from seawater or a pure water producing process from sea water. The method of the present invention comprises contacting the lithium-containing aqueous solution to an adsorbent of lithium-containing manganese oxide, so that lithium ions in the aqueous solution are adsorbed on the adsorbent, characterized in that said lithium-containing aqueous solution has a pH value not less than 10, preferably a pH value of 11. The pH value of the lithium-containing aqueous solution can be raised by adding an alkali, such as NaOH, to the said lithium-containing aqueous solution, for example seawater or said brine.

Preferably, said adsorbent of lithium-containing manganese oxide is a granular adsorbent comprising powder of lithium-containing manganese oxide, and a polymer as a binder. A suitable polymer for use as said binder is poly(vinyl chloride).

The adsorbent of lithium-containing manganese oxide used in the method of the present invention comprises (but not limited to) LiMn₂O₄ or Li₂MnO₃.

A suitable process for preparing said powder of lithium-containing manganese oxide is disclosed in U.S. Pat. No. 4,665,049, details of which are incorporated herein by reference. A typical preparation process comprises: (a) mixing Li₂O and a manganese compound; (b) heating the resulting mixture at a temperature of 300-1200° C. to form a product containing lithium and manganese; and (c) leaching lithium out of the product with an acidic solution.

A suitable process for preparing said granular adsorbent of lithium-containing manganese oxide is disclosed in Japanese patent publication No.3-008439, details of which are incorporated herein by reference. A typical preparation process comprises: dissolving poly(vinyl chloride) as said binder in an organic solvent; mixing said powder of lithium-containing manganese oxide with the resulting solution to form a slurry; passing said slurry through a capillary into a liquid to form granules, wherein said liquid has affinity to the organic solvent and is a nonsolvent to the poly(vinyl chloride); and contacting the granules with an aqueous solution of an acid to elute lithium. Preferably, said organic solvent is N-methyl-2-pyrrolidone (NMP). Preferably, said liquid is water or a mixed liquid of water and alcohol.

Without further elaboration, it is believed that the above description has adequately enabled the present invention. The following specific examples are, therefore, to be construed as merely illustrative, and not limitative of the remainder of the disclosure in any way whatsoever.

### EXAMPLE 1

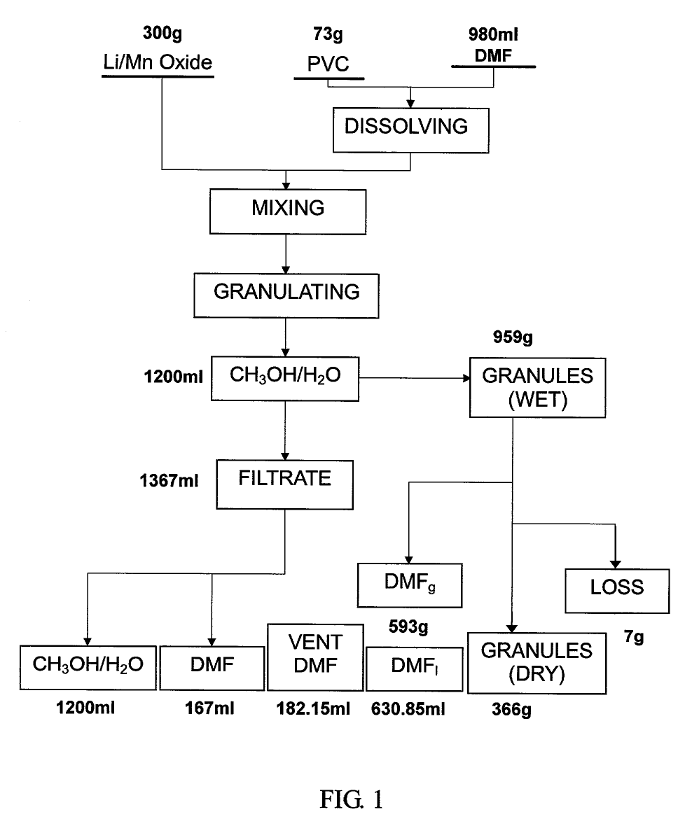

As shown in the flowchart of FIG. 1, 73 g poly(vinyl chloride) (PVC) having a polymerization degree of 620±20 was dissolved in 980 ml DMF. To the resulting PVC solution 300 g of Li_{1.33}Ma_{1.67}O₄ powder in spinel phase was added, and the mixture was then kneaded thoroughly. The kneaded mixture was added drop-by-drop through a capillary (diameter 3 mm) into 1200 ml of a mixed solution of methanol and water (1:1 by volume), and granules having a diameter of 3.5-4.3 mm were formed. The granules and the liquid of the mixture were separated by filtration, and about 959 g of wet granules were obtained. The wet granules were dried in vacuo, whereby about 539 g (630 ml) DMF solvent was evaporated, 366 g of dry granular adsorbent was yielded, and about 7 g of solid was lost. The filtrate of about 1367 ml was separated to yield about 1200 ml of a mixed solvent of methanol and water (1:1 by volume) and 167 ml of DMF. In addition, 182.15 ml of DMF was collected from the exhausted gas. The mass balance between the input and the output was checked by using the weights and volumes measured above, and found correct.

### EXAMPLE 2

The procedures in Example 1 were repeated except that DMF was replaced by N-methyl-2-pyrrolidone (NMP). Granular adsorbent having a diameter of 3.5-4.3 mm was obtained.

The cross sections of the two granular adsorbents prepared in Examples 1 and 2 were observed with electronic microscopy, and numeral pores of about 1 μm were observed with one major difference. The structure of the granular adsorbent prepared in Example 1 (DMF) is in the form of sponge (density 0.33 g/cm³), and the structure of that prepared in Example 2 (NMP) is in the form of feather (density 0.41 g/cm³). The porous structures of the two granular adsorbents are advantageous for lithium to diffuse into the adsorbents.

40 g of the two granular adsorbents prepared in Examples 1 and 2 were packed into a column separately to form an adsorbent bed after being soaked with deionized water. The adsorbent beds were washed with deionized water, 1300 ml of 0.5N HCl aqueous solution, and deionized water again, so as to be ready for an isothermal adsorption test.

LiCl aqueous solutions having different concentrations were prepared. 8 g of the granular adsorbent was taken from the adsorbent bed and mixed with an excess amount of the LiCl aqueous solution. The Li⁺ concentration of the solution was measured by constantly withdrawing a sample therefrom. The test was stopped, when the measure Li⁺ concentration of the solution remained stable, i.e. reaching the Li⁺ equilibrium concentration. The saturated amount of Li⁺ adsorbed per gram of the adsorbent in a LiCl aqueous solution having a particular concentration was calculated from the difference of the Li⁺ amounts contained in the initial LiCl aqueous solution and in the equilibrium solution.

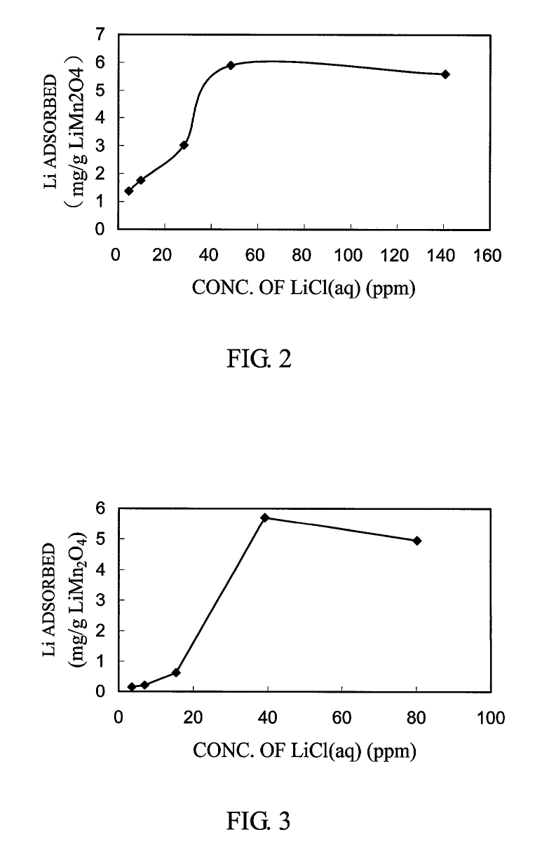

FIGS. 2 and 3 show the results of the isothermal adsorption tests by using the two adsorbents prepared in Examples 1 and 2 in LiCl aqueous solutions of various concentrations at pH=7 and 25° C., respectivel. It can be seen from FIGS. 2 and 3 that the saturated amounts of Li⁺ adsorbed per gram of the adsorbents prepared in Examples 1 and 2 are both about 6 mg/g adsorbent.

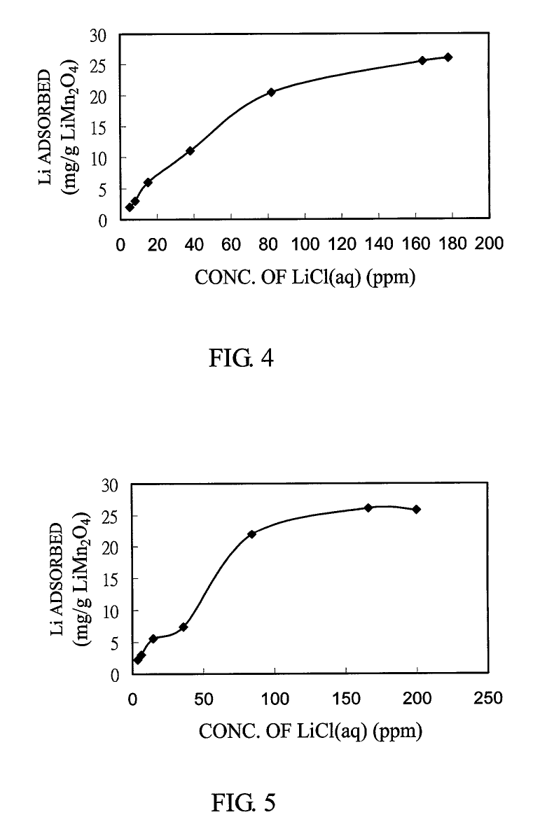

The isothermal adsorption tests were repeated by using LiCl aqueous solutions having a pH of 11, wherein NaOH was added to adjust the pH values of the LiCl aqueous solutions. The results are shown in FIGS. 4 and 5 for the adsorbents prepared in Examples 1 and 2, respectively. It is surprised to find that the saturated amounts of Li⁺ adsorbed per gram of the adsorbents prepared in Examples 1 and 2 are enhanced to both about 25 mg/g adsorbent.

1. A method for adsorbing lithium ions from a lithium-containing aqueous solution by an adsorbent comprising contacting a lithium-containing aqueous solution to an adsorbent of lithium-containing manganese oxide, so that lithium ions in the aqueous solution are adsorbed on the adsorbent, characterized in that said lithium-containing aqueous solution has a pH value not less than 10.

2. The method according to claim 1, wherein said lithium-containing aqueous solution has a pH value of 11.

3. The method according to claim 1, wherein said adsorbent of lithium-containing manganese oxide is a granular adsorbent comprising powder of lithium-containing manganese oxide, and a polymer as a binder.

4. The method according to claim 3, wherein said binder is poly(vinyl chloride).

5. The method according to claim 1, wherein said adsorbent of lithium-containing manganese oxide comprises LiMn₂O₄ or Li₂MnO₃.

6. The method according to claim 3, wherein said powder of lithium-containing manganese oxide is prepared by (a) mixing Li₂O and a manganese compound; (b) heating the resulting mixture at a temperature of 300-1200° C. to form a product containing lithium and manganese; and (c) leaching lithium out of the product with an acidic solution.

7. The method according to claim 6, wherein said granular adsorbent of lithium-containing manganese oxide is prepared by dissolving poly(vinyl chloride) as said binder in an organic solvent; mixing said powder of lithium-containing manganese oxide with the resulting solution to form a slurry; passing said slurry through a capillary into a liquid to form granules, wherein said liquid has affinity to the organic solvent and is a nonsolvent to the poly(vinyl chloride); and contacting the granules with an aqueous solution of an acid to elute lithium.

8. The method according to claim 7, wherein said organic solvent is N-methyl-2-pyrrolidone (NMP).

9. The method according to claim 7, wherein said liquid is water or a mixed liquid of water and alcohol.

10. The method according to claim 1, wherein said lithium-containing aqueous solution comprises seawater, or brine generated from a process for producing salt from seawater or a pure water producing process from seawater; and an alkali added to said seawater or said brine.

11. The method according to claim 10, wherein said lithium-containing aqueous solution comprises said brine; and said alkali is NaOH.
